(19) United States
(12) Patent Application Publication
(10) Pub. No.: US 2008/0301127 A1
(43) Pub. Date: Dec. 4, 2008

(54) Method and Apparatus for Providing an On-Line Directory Service

(76) Inventors: Paula Gilmer, Dublin (IE); Eleanor Manny, Dublin (IE); Shane Broadberry, Dublin (IE); Chad Gilmer, Dublin (IE)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 12/128,550

(22) Filed: May 28, 2008

(30) Foreign Application Priority Data
May 28, 2007 (IE) S2007-0382

(51) Int. Cl. G06F 7/06; G06F 17/30; G06F 17/00

(52) U.S. Cl. 707/5; 715/273; 707/E17.014

(57) ABSTRACT

A method and apparatus for providing an on-line directory service is described. By providing search results in a graphical tapestry it is possible to provide more search results on a browser window, thereby minimising the requirement for a user to scroll through a sequential listing. The search results are provided in a graphical format, each of the resultant graphics being dimensioned appropriately depending on its ranking within the search results.

### FIELD OF THE INVENTION

The present invention relates to directories and in particular to an on-line directory service. The invention more particularly relates to a computer implemented method and apparatus for providing such directory services.

### BACKGROUND

Directories are well known. For many years a consumer has traditionally turned to paper directories such as the Goldenpages™ when looking for a particular service provider. Advertisers within such an environment pay different amounts depending on the level of exposure that they wish. When the paper directory is printed, different sections are dedicated to different services so that a person can turn to a particular section and then determine from the displayed advertisements who they wish to select to contact. By enabling the advertiser to present their company presentation in one or more graphical formats, as well as providing a simple listing of the subscribers to the directory service, it is possible that one particular advertiser will present a better visual impression than others. In this way the user of the directory service may be motivated to select that service provider over the others that are in the directory.

While this has been a successful way for many service providers to advertise their products and services, in recent times people have turned away from paper based directories and more to the internet when searching for particular service providers. Websites such as internet search engines Google™, Ask Jeeves™, Goldenpages.ie™ or Switchboard.com™ all offer an on-line directory service where an advertiser can subscribe to the search engine operator in order to improve the ranking of their service or product in a search result listing. While this has proved to be a successful model, where there are a number of service providers that match a search criteria, the resultant display is difficult for a user of the website to differentiate between each of the service providers. By providing a listing, be that alphabetical or determined based on the match criteria to the search terms, the user of the website is required to scroll down through the listing to ascertain whether a particular service provider meets their requirement.

Such a display mechanism does not intuitively meet the user search criteria in that through a simple listing mechanism it is difficult for a user to determine or make a selection for a particular service provider. Furthermore, it is difficult for a service provider to distinguish their products or services from those of others. However, heretofore it has not been technically possible to provide any alternative display mechanism. In this way while different directories may differ in the type of search that they offer and how this may be tailored for specific criteria, they all share the same display of the results.

There is therefore a need to provide an improved method and system that may be used in an on-line directory service to assist in optimising the search results based on specific search criteria.

### SUMMARY

These and other problems are addressed in accordance with the teaching of the invention by providing for a display of the search results in a way that occupies the screen of the user making the search. In this way it is possible to differentiate different regions of the screen according to their position on the screen and to allocate these regions in a prioritised fashion. By effecting a display of the search results for specific search criteria in a graphical format and locating these resultant graphics in regions of the screen corresponding to their ranking in the search results, it is possible to provide the user with a more intuitive search result, and as a result motivate the user to select one service provider over another.

Accordingly, a first embodiment of the invention provides an on-line directory configured to provide a user with one or more results dependent on a user input search request, the directory including a web server having: a data store configured to associate one or more service providers with specific search criteria, the search criteria serving to differentiate one service provider from another service provider, a communication port configured to receive search requests from one or more remote users, the user having input the search request through a browser window operable on a computing device of the user, a search engine configured to determine from the search requests an appropriate search result, the search result including a plurality of service providers ranked according to the relevance of the search request to the search criteria associated with the individual search providers, a mapping engine configured to define the browser window into a plurality of graphical regions, each of the graphical regions having a specific location across the window, a population engine configured to populate the graphical regions with graphics representative of the results of the search request so as to form a tapestry within the browser window, the individual result graphics being displayed within the tapestry at a location dependent on their ranking within the search results.

The dimensions of the displayed result graphic for a specific service provider may be dynamically related to the ranking of that service provider within the search results. The graphics used within the formation of the tapestry could be in the form of a static or a moving image with or without sound associated therewith. One or more of the graphics could be representative of three dimensional shapes or could be provided as a two dimensional shape.

At least one of the populated graphical regions typically includes a dynamic feed.

The search criteria may include at least one dynamic integer.

In an aspect of the invention at least one of the graphical regions is populated with a graphic representative of a three dimensional shape. In such an aspect, the three dimensional shape may include a number of faces, individual ones of the faces being configured to enable a user to click through the face for further information relevant to the graphic displayed on that face. Such a three dimensional shape may be moveable by a user interacting with the browser window.

The mapping engine is desirably configured to define the browser window based on a dynamic interrogation of the browser window characteristics.

The mapping engine and population engine may be configured to iteratively interact during formation of the tapestry.

The directory may include means configured to enable a user to select a subset of the displayed graphics for subsequent analysis and/or storage.

These and other features of a directory in accordance with the teaching of the invention will be better understood with reference to any one of the accompanying Figures.

### BRIEF DESCRIPTION OF THE DRAWINGS

The present invention will now be described with reference to the accompanying drawings in which:

FIG. 1 is an example of a directory in accordance with the teaching of the invention.

FIG. 2 is a flow chart showing how a service provider may be registered with a directory in accordance with the teaching of the invention.

FIG. 3 shows a data structure in accordance with the teaching of the invention.

FIG. 4 shows how a user may interrogate the directory in accordance with the teaching of the invention.

FIG. 5 shows how a system in accordance with the teaching of the invention may be configured to map and populate a browser window.

FIG. 6 shows an example of a generated tapestry on a browser in accordance with the teaching of the invention.

FIG. 7 shows how a subset may be generated for subsequent interrogation in accordance with the teaching of the invention.

### DETAILED DESCRIPTION OF THE DRAWINGS

The invention will now be described with reference to exemplary embodiments thereof which are provided to assist in an understanding of the teaching of the invention but are not to be construed as limiting in any fashion except as may be deemed necessary in the light of the appended claims. Where specific features or components are described with reference to any one figure it will be understood that these may be interchanged or replaced with those from other figures or other components without departing from the teaching of the invention.

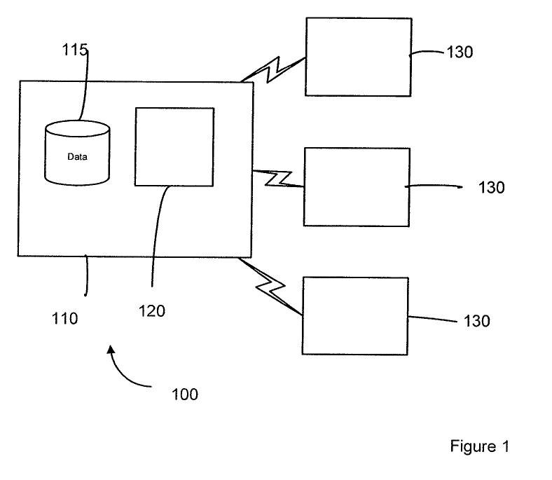

As shown in FIG. 1, a system 100 in accordance with the teaching of the invention includes a web server 110 configured to include a data store 115 which may be accessed and processed through one or more executable software modules running on a processor 120. The web server 110 is accessible over conventional internet protocols by one or more remote users 130, each of which access the web server using its Uniform Resource Locator (URL) via an internet browser executable on their local machine. Such access may be via a wired or wireless communication link. Furthermore the remote users may be accessing the web server via a Personal Digital Assistant (PDA) or other wireless enabled mobile device, in which case it will be appreciated that the browser executing on their local device will re-configure displayed web pages generated by the web server to match the limitations of the graphical user interface or screen on their local device.

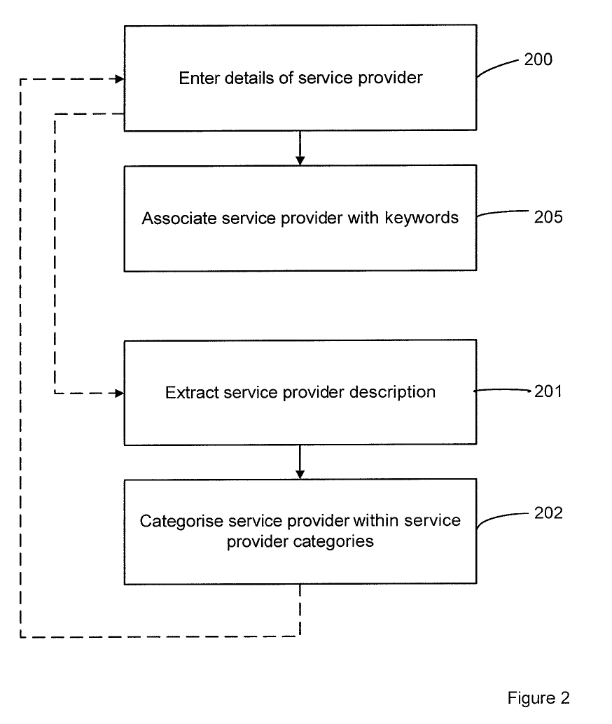

As shown in FIG. 2, in order to implement a directory service it is necessary to initially populate the data store 115. The data store is desirably configured as a relational database such as those provided by MySQL™, Oracle™, Microsoft™ or the like. With such relational databases one or more tables are characterised with different heading and populated accordingly. Such population of databases of this type will be well known to the person skilled in the art. The population of the data store may be considered as entering details of particular service providers (Step 200) and associating the individual service providers with particular keywords or search criteria (Step 205). The step of entering the details of the service provider may include extraction of a company description (Step 201) and also the categorisation of the company within predefined product criteria. It will be understood that throughout this description that the terms “service provider” is intended to encompass a provider of both services and products, and similarly the term “product” is intended to encompass both products and services.

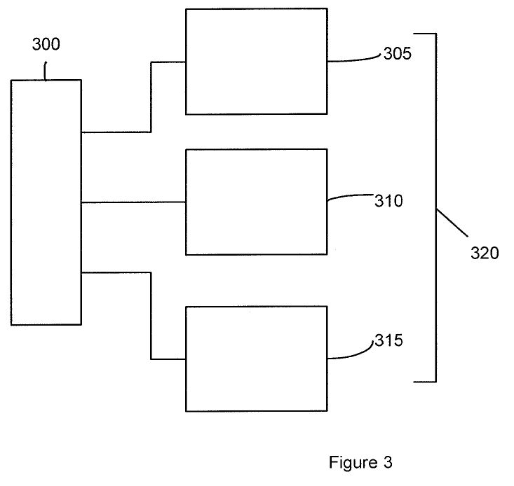

As shown in FIG. 3, as a result of the initial population of the data store, a specific company 300 is linked to a set of searchable criteria 320 including a company category 305, a company description 310 and a set of one or more keywords 315. Each of these criteria may be subsequently used to effect a retrieval of appropriate company listings from a search request affected by a user.

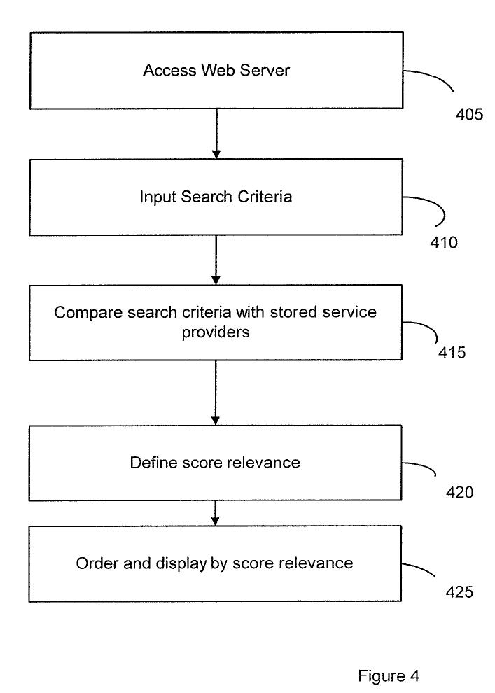

FIG. 4 shows in schematic form how a user search request is interrogated to effect a retrieval of appropriate companies for subsequent display. Initially the user will access the web server through a conventional browser as discussed above (Step 405). On accessing a search page displayed on the user browser by the web server response, the user may then input a search criteria (Step 410). This could be one or more of a company name, company location, company category, etc., as will be appreciated by those skilled in the art. The web server, on retrieval of these search criteria effects a lookup of the previously stored company information within the data store (Step 415).The lookup will effect a determination of a score relevance, based on the match of the search terms to each of the identified companies, with each company retrieved being allocated a unique score relevance (Step 420). Based on the score relevance achieved by the individual companies it is possible to then rank and display the companies for the user to view on their user interface.

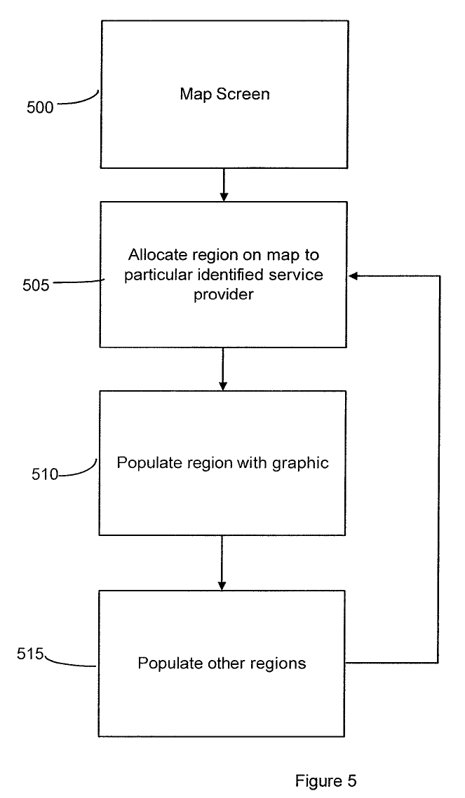

As shown in FIG. 5, the step of ordering and displaying the search results that was detailed in FIG. 4 (Step 425), includes a number of steps. The invention provides a mapping engine configured for providing a mapping of the display screen of the user display into a number of different regions. This is desirably effected by defining the screen as comprising a number of pixels on an X-Y grid (Step 500). This definition could be effected on a predetermined template basis whereby the screen is considered independently of the client browser being used to access the server or could be effected using an interrogation of the browser capability and defining the screen size based on that capability on a case by case basis. Once a screen size has been determined then the engine may be utilised for allocating particular coordinates on that grid for display of particular search results dependent on their ranking in the search result (Step 505). Within the mapped screen different regions are prioritised depending on their location on the screen, for example the top left hand side region of the screen is considered a high impact location and is reserved for the company having the highest ranking from the score relevance. Once a company in the ranked list is allocated a specific region, an appropriate dimensioned graphic for that company is retrieved (Step 510) and a specific portion of the mapped screen is populated using that graphic. Such population of the mapped window may be considered the functional responsibility of a mapping engine. Once that particular region is populated then other regions are sequentially populated (Step 515) until all the search results are allocated a region within the mapped screen. This may require a looping or iterative allocation and retrieval of graphics.

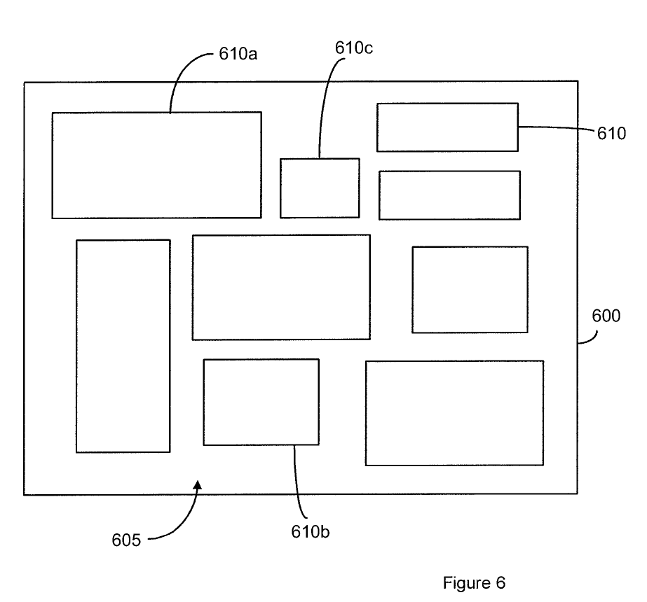

It will be understood that as the invention teaches that the search results are presented in a graphical layout at a specific location on the screen dependent on their ranking in the search results, that it is necessary to associate a graphical image indicative of each company with each company stored in the data store. As opposed to providing a sequential list, the invention teaches the results are presented in a tapestry effect on the screen. An example of such a screen 600 is shown in FIG. 6.

As is evident from FIG. 6, a search tapestry 605 generated as a result of the teaching of the invention includes a number of individual and differently dimensioned graphical boxes 610 whose location relative to one another and on the screen is determined by their ranking from a search criteria input by a user. A company that scores well, and is therefore is high in the search results is allocated a dominant position and a large dimensioned graphical box 610a, whereas a company that is ranked much lower is located in a more cluttered environment on the screen and is allocated a smaller dimensioned box, 610b. As the number of displayed boxes is highly dependent on the search criteria used and is therefore a dynamic feature of the system, in order to ensure that individual areas within the display screen are not under populated, the invention also teaches the use of filler boxes, 610c, who are not associated with any one company but do present a graphic logo to occupy a location that would otherwise be empty.

It is possible to provide a double ranking benefit whereby a specific location and size of the presented graphic are related to the ranking of the service provider in the search results. In this way not only will a higher ranking result in a preferred location but also the dimensions of the allocated graphic will be related to the search results. In this way the size of the displayed graphic will be related to the ranking of the service provider within the search results. This may involve a stretching or shrinking of a provided graphic to meet the result of the search strategy conducted.

The ability to stretch or shrink the displayed graphic to meet the search results may be considered an example of an intelligent graphic. When displaying individual graphics at specific regions within the screen, the system of the present invention may be configured for providing for certain of the generated graphics to be provided in a three dimensional form as opposed to the traditional two dimensional form that one traditionally encounters in websites. By providing a three dimensional graphic which it will be appreciated will have a number of different faces or facets, each of the facets may be used as a display face for a certain aspect of the generated result. In this way where a service provider provides a number of different services under the same umbrella organisation, different facets could be used to link through to further information on different aspects of the specific services. The user may be provided with the ability to rotate the three dimensional graphic through use of a mouse control or some other screen interface tool. The implementation of such a three dimensional graphic could be implemented using one of a number of different web authoring tools such as FLASH™.

The system of the invention may also be configured to rank the displayed service providers using a colour code whereby the displayed graphics will be colour coded depending on one or more criteria. By using techniques such as heat maps where different colours indicate level of popularity or the like, the user is conveyed a sense of underlying characteristics of the individual service providers through a visual inspection of the tapestry that is provided through the ranking of the service providers in response to the search strategy conducted.

As part of the search criteria that are used to effect the display tapestry, the system in accordance with the teaching of the invention may adopt a time discriminatory function, where the results that are displayed are related to the access time that the user has accessed the server. For example if the user wishes to search for “restaurants” and accesses in the morning, then the search results may include those restaurants that provide a breakfast menu. Other examples could include the provision of an intelligent graphic where a service provider could include a direct feed to the displayed graphic giving real time up to date information. As an example of this dynamic feed that could be implemented using for example SOAP XML protocols, it could be possible to give an indication of stock levels or for example in the context of a hotel or restaurant the numbers of rooms/tables available. Such a dynamic feed could also be used as a component of the search criteria where the search results were displayed based on matching criteria that could be updated dynamically by the service provider as opposed to static predefined criteria. In this way if a user was searching for a restaurant with availability for 20 people, only those restaurants with that capacity would be displayed.

The invention will now be described with reference to an example, that of a search for the search phrase “Computer training Excel”.

First Check full string phrase “Computer Training Excel” against the following fields in Database

Full Phrase get a Multiplier (2)

Company Name: (Score=5)*2

Company Description: (Score=3)*2

Category Name: (Score=7)*2

Keyword Phrase Match: (Score=4)*2

Above obtains a Search Relevance SCORE

Results are displayed and ordered by the following criteria

SCORE Desc, Y-Position ASC, X-Postion ASC, Cube-Size DESC

### Display Algorithm

Record set of search results, in sequential order to be loaded, are obtained that contain X-position, Y-Position and Cube Type (e.g. 1×2 or 3×3).

System takes the first result to be displayed and positions the graphic Cube in the top most left corner that contains enough space available to fit into.

The system cycles through the result set one by one and for each result starts at top left most position and moves across from left to right checking for an available space. If a space is found it examines the Cube Type and checks if there is an available space for that graphic Cube to fit. The system will continue to move downwards until an available space is found using the process above.

The above algorithm is optimised to run dynamically for each search and displays the position on each search run in real-time.

The following is an example of the code instruction that could be used to implement such an algorithm.

Create a blank empty grid - 5 columns wide and unlimited height.
Loop thru recordset for each record
Loop from Top
Loop from Left to Right
if empty grid space then
Loop from current Left-Pos to (Current Left-Pos + Cube-W)
Loop from current Top-Pos to (Current Top-Pos + Cube-H)
if space it NOT_AVAILABLE
FLAG as NOT_AVAILABLE
End if space Not Available
End Top-Pos Loop
End Left-Pos Loop
if (FLAGGED as AVAILABLE)
Store in GRID that this space is NOT_AVAILABLE
Assign Advert(CUBE) new Top-Pos and new Left-Pos
end if Flagged as Available
end if empty grid space
End Left to Right Loop
End Top Loop
End Recordset Loop

It will be understood that such a code flow is exemplary of the type of arrangement that could be used to effect the requisite display in accordance with the teaching of the invention.

While the search criteria used has been described with reference to FIG. 3 and company descriptor, category type and keyword, it will be understood that other search criteria such as location could also be useful in implementing the teaching of the invention. For example, as part of the company description a company geographic location could be specified and this could be used to rank searches based on a request for a particular company within a specific region. Furthermore, by using geographical intelligence based systems it is possible to provide a listing of those companies within a defined geographic region relative to the search criteria, for example within 5 km of a specific town or location. It is also possible to interrogate the user client device to ascertain from which geographic location that client has accessed the web server and then providing results which are relevant to that geographic location.

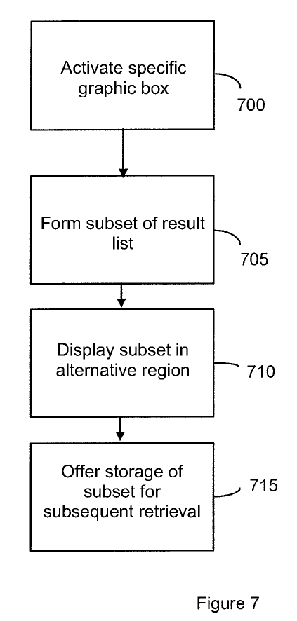

FIG. 7 shows a further aspect of the invention which is advantageous for a user of the system. By providing each of the displayed graphics as an intelligent graphic box, a user can use their point and click device such as a mouse to activate one or more of the displayed graphical boxes (Step 700). The activated boxes can then be used to form a subset of the initial search results (Step 705). This subset may then be displayed in a different region or tab or page of the browser window (Step 710). Additionally the user may be provided with the choice to store that list for subsequent retrieval and examination (Step 715). By using such intelligent boxes where the data in each of the graphical boxes may be interfaced by the user it is also possible to offer a facility whereby the user may directly contact the service provider identified in the graphic box by means of an electronic mail communication or phone call or some other form of data communication.

It will be understood from the description heretofore that a system and methodology in accordance with the teaching of the invention addresses the problem commonplace with search results—that of the search result listing being too long and requiring the user to scroll down through a number of pages. By providing the search results in a graphical format and then display each of the graphics in a tapestry across the browser window it is possible to provide a user with a higher number of alternatives per screen shot than heretofore possible. By obviating the need for the user to scroll down their browser window the user is able to ascertain the results in a much more meaningful and intuitive fashion than heretofore possible. Furthermore as the displayed results are dimensioned according to their ranking resultant from the search criteria, it is still possible for a user to differentiate between those that are more appropriate to them as opposed to others.

Therefore while the invention has been described with reference to exemplary embodiments of a method and system for providing a directory service it will be understood that modifications can be made to the features and components heretofore described without departing from the scope of the invention which is to be limited only as may be deemed necessary in the light of the appended claims.

The words comprises/comprising when used in this specification are to specify the presence of stated features, integers, steps or components but does not preclude the presence or addition of one or more other features, integers, steps, components or groups thereof.

1. An on-line directory configured to provide a user with one or more results dependent on a user input search request, the directory including a web server having:
a data store configured to associate one or more service providers with specific search criteria, the search criteria serving to differentiate one service provider from another service provider;
a communication port configured to receive search requests from one or more remote users, the user having input the search request through a browser window operable on a computing device of the user;
a search engine configured to determine from the search requests an appropriate search result, the search result including a plurality of service providers ranked according to the relevance of the search request to the search criteria associated with the individual search providers;
a mapping engine configured to define the browser window into a plurality of graphical regions, each of the graphical regions having a specific location across the window; and
a population engine configured to populate the graphical regions with graphics representative of the results of the search request so as to form a tapestry within the browser window, the individual result graphics being displayed within the tapestry at a location dependent on their ranking within the search results.

2. The directory of claim 1 wherein the dimensions of the displayed result graphic for a specific service provider are dynamically related to the ranking of that service provider within the search results.

3. The directory of claim 1 wherein at least one of the populated graphical regions includes a dynamic feed.

4. The directory of claim 1 wherein the search criteria include at least one dynamic integer.

5. The directory of claim 1 wherein at least one of the graphical regions is populated with a graphic representative of a three dimensional shape.

6. The directory of claim 5 wherein the three dimensional shape includes a number of faces, individual ones of the faces being configured to enable a user to click through the face for further information relevant to the graphic displayed on that face.

7. The directory of claim 6 wherein the three dimensional shape is moveable by a user interacting with the browser window.

8. The directory of claim 1 wherein the mapping engine is configured to define the browser window based on a dynamic interrogation of the browser window characteristics.

9. The directory of claim 1 wherein the mapping engine and population engine are configured to iteratively interact during formation of the tapestry.

10. The directory as claimed in claim 1 including means configured to enable a user to select a subset of the displayed graphics for subsequent analysis and/or storage.

11. A method of displaying the results of a query performed on a search engine, the results being a plurality of entities, the method comprising:
retrieving an image for each of the entities; and
arranging the images into a mosaic to fill a frame within a browser window.

12. The method of claim 11 wherein the arranging step includes a determination of the size of frame available.

13. The method of claim 11 wherein the arranging step includes adjusting the relative sizes of the images to form the mosaic.

14. The method of claim 13 wherein the adjustment made to an individual image is related to its associated entities ranking in the result.

15. The method of claim 11 including associating a link with each of the images.

16. The method of claim 15 wherein the link is related to the entity associated with the image.
